(19) United States
(12) Patent Application Publication
(10) Pub. No.: US 2026/0139907 A1
(43) Pub. Date: May 21, 2026

(54) Electrostatically Charged Drift Eliminators to Remove Liquid Droplets From An Air Flow

(71) Applicant: Evapco, Inc., Taneytown, MD (US)

(72) Inventors: Jean-Pierre Libert, Frederick, MD (US); Mark Huber, Sykesville, MD (US); Zack Russell, Hanover, PA (US); Aaron Reilly, Gettysburg, PA (US)

(21) Appl. No.: 19/395,939

(22) Filed: Nov. 20, 2025

Related U.S. Application Data
(60) Provisional application No. 63/722,810, filed on Nov. 20, 2024.

(51) Int. Cl. F28C 1/16; B03C 3/08; B03C 3/47; F28C 1/02; F28C 1/04

(52) U.S. Cl. CPC F28C 1/16; B03C 3/08; B03C 3/47; F28C 1/02; F28C 1/04

(57) ABSTRACT

A drift elimination system for evaporative heat rejection equipment. The drift elimination system includes a first and second set of electrodes positioned apart from one-another in the air flow downstream of the fill and spray system. The first set of electrodes, optionally in the form of needles or thin plates are energized with a positive or negative charge. The second set of electrodes, optionally in the form of wavy plates or a wire mesh are energized with the opposite charge. Water droplets passing over or through the first set of electrodes accept a charge from the first set of electrodes and are attracted to the second set of electrodes where they are collected, removing the charged droplets from the airflow, reducing water loss and abating plume formation.

### FIELD OF THE INVENTION

This invention relates to evaporative cooling towers.

### BACKGROUND OF THE INVENTION

The warm, humid effluent air from evaporative heat rejection equipment such as wet cooling towers, usually called cooling tower plume, typically has a relative humidity greater than 90%, and often a relative humidity of 100%, or more, under fogging conditions, high ambient relative humidity and/or cold ambient air temperature. In most common cases of operation, the effluent air is saturated with moisture. When the effluent air reaches or slightly exceeds saturation, the water vapor in the effluent air recondenses and forms small water droplets, typically of a diameter ranging from a few microns to about one hundred microns. The recondensed water droplets are chemically pure. The small droplets make the plume visible like fog, which can be dense (see, e.g., FIG. 1).

The heat rejection equipment plume contains also larger droplets, called drift droplets, which are lifted and carried over from the fill and water spray area by the cooling airflow generated by motorized fans, or by the natural draft effect created by a tall shell such as in the case of hyperbolic (natural draft) cooling towers. The drift water droplets have the same chemistry as the recirculating cooling water. Evaporative heat rejection equipment usually includes drift eliminators to reduce to a minimum the amount of drift droplets carried off. Drift droplets, having the same chemistry as the recirculating cooling water, are usually considered to contain particulate matter measuring less than 10 microns (PM₁₀). Accordingly, they contribute to particulate emissions from the plant and must be included in the plant permitting process.

State-of-the-art drift eliminators are made by assembling thin sheets of polymer, such as PVC or polypropylene, which have been formed in wavy shapes by thermoforming, vacuum forming or extrusion processes (see, e.g., FIGS. 5A-5C). The assembled polymer sheets form packs or panels, which are usually installed at a distance above, or downstream of, the cooling tower fill and spray system, see, e.g., FIGS. 2-4.

Currently, best available technology eliminators can reduce drift to below 0.0005% of circulating flow in mass. Drift droplet size is highly dependent on spray nozzle type and spray pressure, air velocity and water loading, and to some extent, water chemistry. Drift droplets typically have a diameter ranging from tens of microns to several hundreds of microns, see, e.g., FIG. 6.

### SUMMARY OF THE INVENTION

There is presented according to the invention, a drift elimination system comprising first and second electrodes (or first and second sets of electrodes) located in a liquid droplet-containing air flow. The drift elimination system may be used in any application where the prevention or reduction in the escape or loss of liquid droplets is desired. Non-limiting examples include evaporative heat rejection systems such as cooling towers and coolers. Other examples include air contactor systems for the removal of carbon dioxide or other pollutants from air using a liquid reaction fluid. At least one first electrode is located downstream of water/reaction fluid dispersion media in an air-flow direction and configured to impart an electrical charge to water droplets passing by or through the at least one first electrode. For the purposes of this invention the term “downstream” shall mean downstream in the air-flow direction. At least one second electrode is located downstream of the at least one first electrode in an air-flow direction and is configured to be energized with an opposite electrical charge from the at least one first electrode. The first electrode(s) may be made of any type of electrical conducting material and preferably comprise an array of metal needles or a plurality of metal plates. The second electrode(s) may be made of any type of electrical conducting material and preferably comprise a set of wavy metal plates or wire mesh.

The drift elimination system of the invention may be installed below a fan and above a water distribution system in a counterflow evaporative cooling tower or laterally adjacent to a heat exchange area containing water dispersion media in a crossflow evaporative cooling tower. Alternatively, in the case of a crossflow evaporative cooling tower, the drift elimination system may be installed just below the fan, but in any event, vertically higher than a water distribution system. In the case of a natural draft cooling tower, the drift elimination system of the invention may be installed in the throat of the tower. In the case of an air contacting system, the drift elimination system of the invention may be installed downstream of the reaction fluid dispersion media/reaction unit and upstream of the air moving unit/fan array.

The drift elimination system according to the invention may also optionally include one or more polymer sheet drift eliminator packs of the prior art located upstream in said air-flow direction of said first electrode(s).

It is specifically noted that every combination and sub-combination of the above-listed and below-described features and embodiments is considered to be part of the invention.

### BRIEF DESCRIPTION OF DRAWINGS

The foregoing summary, as well as the following detailed description of the preferred invention, will be better understood when read in conjunction with the appended drawings. For the purposes of illustrating the invention, there are shown in the drawings embodiments which are presently preferred. It should be understood, however, that the invention is not limited to the precise arrangements and instrumentalities shown. In the drawings:

FIG. 1 shows an example of a cooling tower plume.

FIG. 2 is a schematic of a counterflow mechanical draft wet cooling tower with prior art drift eliminators.

FIG. 3 is a schematic of a crossflow mechanical draft wet cooling tower with prior art drift eliminators.

FIG. 4 is a schematic of a natural draft counterflow wet cooling tower with prior art drift eliminators (“DEs”).

FIG. 5A shows an example of a prior art drift eliminator.

FIG. 5B shows another example of a prior art drift eliminator.

FIG. 5C shows yet another example of a prior art drift eliminator.

FIG. 6 is a chart showing water droplet size distribution in a counterflow mechanical draft wet cooling tower with a prior art drift eliminator.

FIG. 7 shows an example of a wavy thin plate configuration for the second set of electrodes according to an embodiment of the invention.

FIG. 8 a schematic of a counterflow mechanical draft wet cooling tower according to an embodiment of the invention.

FIG. 9 is a schematic of a crossflow mechanical draft wet cooling tower according to an embodiment of the invention.

FIG. 10 is a schematic of a crossflow mechanical draft wet cooling tower according to an alternate embodiment of the invention.

FIG. 11 is a schematic of a natural draft counterflow wet cooling tower according to an embodiment of the invention.

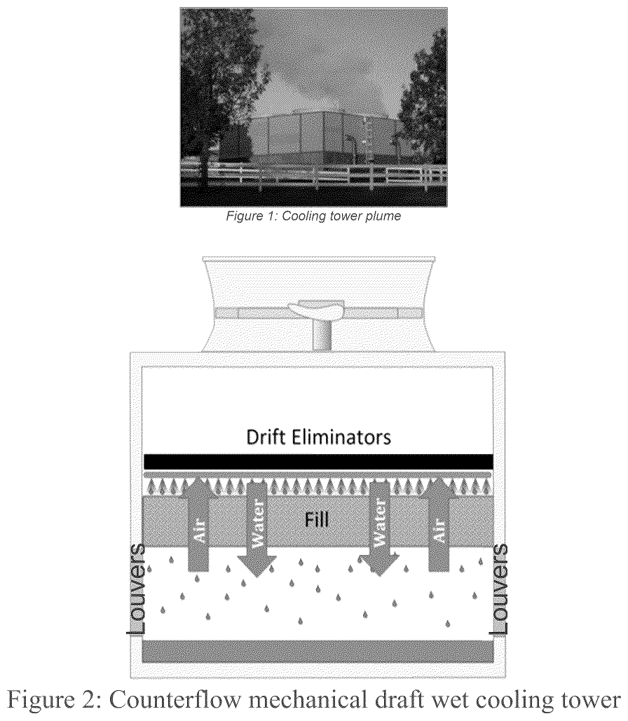

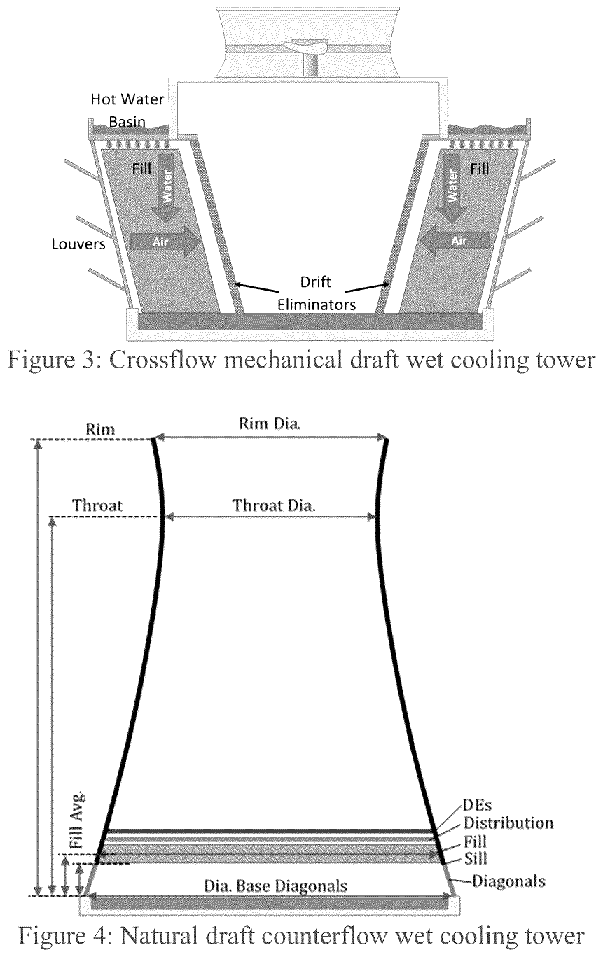

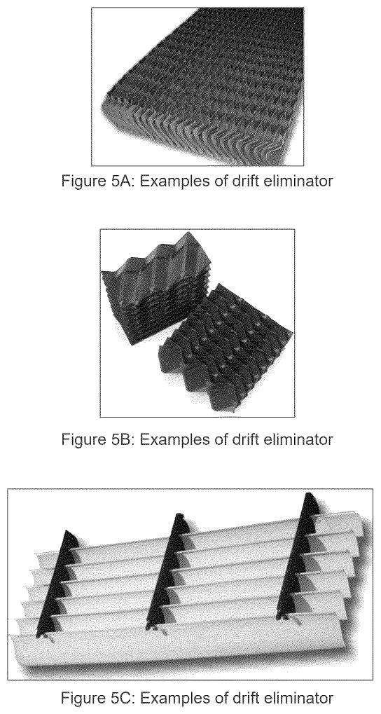

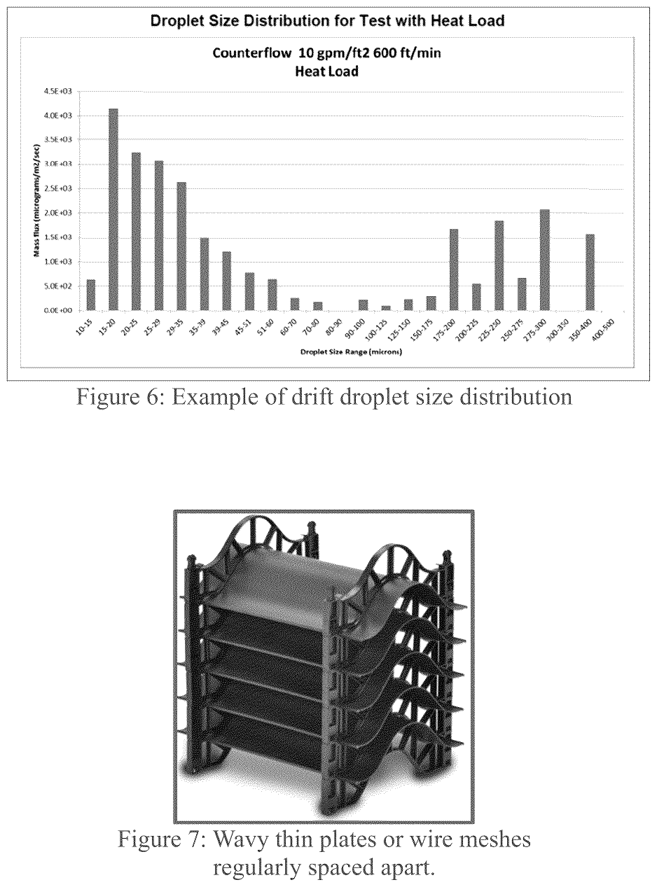

### DETAILED DESCRIPTION OF THE INVENTION

The invention presented is a novel drift eliminator system having first and second set of electrodes spaced apart in the air flow downstream of the spray nozzles/water delivery system in an evaporative heat rejection system, such as a cooling tower or cooler or downstream of the reaction unit in an air contactor system for the removal of carbon dioxide and other pollutants from air.

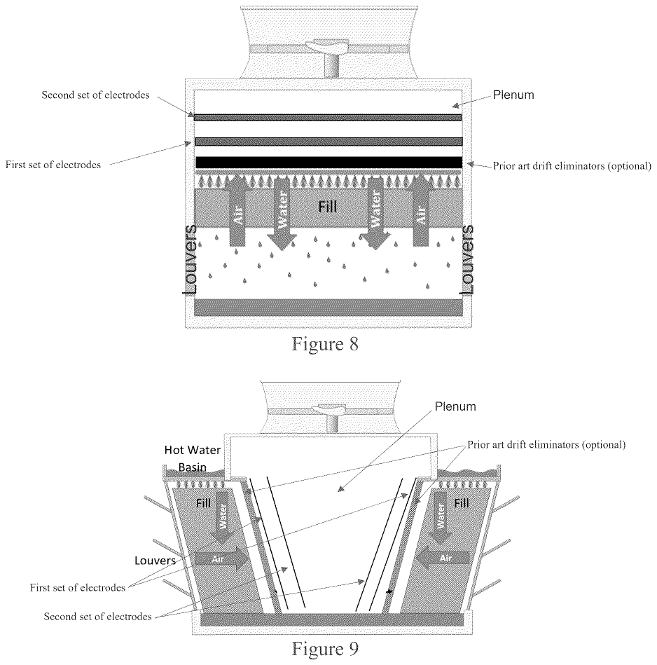

Without limiting the scope of the invention, the details of the invention will now be explained in the context of its implementation in a cooling tower. The first set of electrodes are preferably an array of needles or thin plates, although any type of electrode that will impart a charge to the passing water droplets can serve as the first set of electrodes. The first set of electrodes are preferably installed vertically above (in the case of a counterflow cooling tower) or downstream in an airflow direction (in the case of a crossflow cooling tower) the fill and spray nozzles. At a distance beyond the first set of electrodes in the direction of air flow a second set of electrodes are installed. This second set of electrodes effectively act as charged drift eliminators, by virtue of the water droplets having received an opposite charge from the first set of electrodes. According to a preferred embodiment, the second set of electrodes may be a network of thin metallic wavy plates, or wavy metallic wire meshes, regularly spaced apart (see, e.g., FIG. 7). In counterflow and crossflow cooling towers of standard construction, both first and second sets of electrodes may be installed in the plenum chamber of the heat rejection equipment (FIGS. 8-10). In the case of a natural draft cooling tower, the first and second sets of electrodes may be placed in the throat of the tower (FIG. 11). The first and second sets of electrodes are energized to opposite polarities under high voltage. For example, the first set of electrodes may be wired to the negative pole of a high voltage power supply, and the second set of electrodes may be wired to the positive pole of the high voltage power supply, or vice-versa.

Liquid water droplets that are entrained in the air flow can be electrically charged by induction by putting them in an electric field created by high voltage applied to the first set of electrodes. In the process of induction charging, the electric charge is induced on the surface of the liquid droplets. Electric charge accumulated at the surface of a liquid droplet allows for control of the droplet trajectory in an electric field, and ultimately for the capture of liquid water droplets on the second set of electrodes with an opposite electric charge.

Thus, water droplets, including both recondensed water droplets and drift droplets, are electrically charged when they pass by or through the first set of charged electrodes. Then the charged water droplets are attracted by the opposite polarity when they pass through the oppositely charged second set of electrodes. The droplets captured on the second set of electrodes may be allowed to fall back onto the fill and into the basin or may be collected by a system of gutters and troughs and redirected to a collection tank outside the heat rejection equipment. The collected water can be recycled into the heat rejection equipment, or used for other purposes, thereby reducing the amount of water consumed by the evaporative heat rejection equipment, reducing the amount of chemicals used to treat the cooling water, and reducing the visibility of the plume or eliminating it entirely.

According to various embodiments of the invention, the first and second sets of electrodes may be placed in the plenum of a counterflow mechanical draft cooling tower having a water collection basin, a heat rejection/heat exchange area containing water dispersion media, also known as fill, a water distribution system, including spray nozzles located above the fill, optional prior drift eliminators above the water distribution system and/or spray nozzles, and an air mover, such as a fan. See, e.g., FIG. 8.

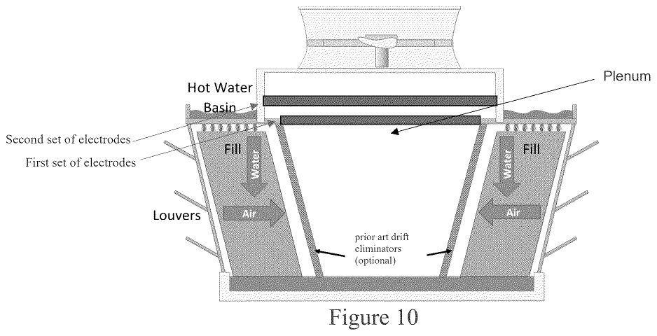

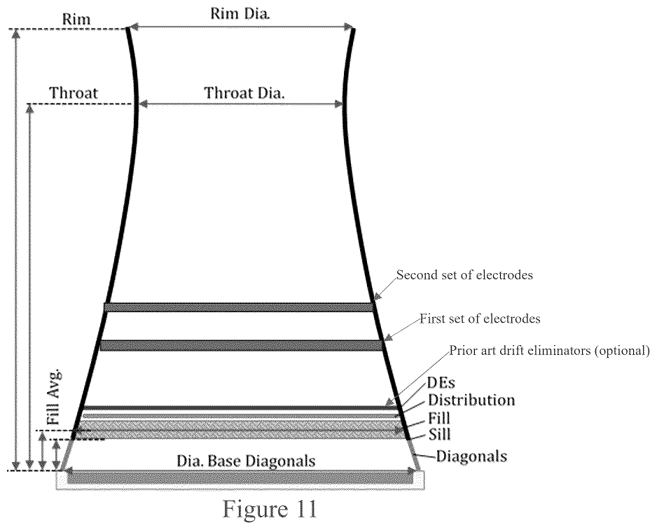

According to other embodiments of the invention, the first and second sets of electrodes may be placed in the plenum of a crossflow mechanical draft cooling tower, having a water collection basin, a heat rejection/heat exchange area containing fill, a water distribution system located above the fill. According to the crossflow embodiments, the first and second sets of electrodes may be located laterally adjacent to the heat exchange/fill area, see FIG. 9, or they may be horizontally oriented and centrally located in an upper part of the plenum as shown, for example in FIG. 10.

According to still further embodiments of the invention, the first and second sets of electrodes may be placed in the throat of a natural draft cooling tower as shown in FIG. 11.

According to other embodiments of the invention, the first and second electrodes may be placed in the liquid droplet containing airflow of any system in which the prevention or reduction in escape or loss of liquid is desired, such an air contactor system for the removal of carbon dioxide and/or other pollutants from air using a reaction fluid. See, e.g., US 2022/0184553, the entirety of which is incorporated herein by reference.

Among the various advantages of the invention is its ability to increase or optimize the quantity of recondensed water vapor in the effluent air inside a cooling tower. This may be achieved by introducing ambient air through dampers or vents strategically located below, or upstream in the path of airflow, of the first set of electrodes, and to mix a controlled amount of ambient air with the effluent air.

Other benefits of this invention include:
Less visible plume: the reduction of the plume visibility allows for easier, faster site selection, permitting, commissioning, and operation of the heat rejection equipment.
Less drift: the reduction of the amount of drift to levels potentially below the detection levels of current field measurement methods reduces the amount of PM10 emissions from the heat rejection equipment, thereby allowing easier, faster site selection, permitting, commissioning, and operation of the heat rejection equipment.
Less consumption of water: the water droplets that are recovered, both recondensation and drift, reduce the consumption of fresh water needed to operate the evaporative heat rejection equipment, thereby allowing easier, faster site selection, permitting, commissioning, and operation of the heat rejection equipment.
Less consumption of water treatment chemicals.

Notwithstanding the specific embodiments, features, elements, combinations and sub-combinations disclosed herein, it is expressly considered and here disclosed that every single element, every single feature, and every combination and sub-combination thereof disclosed herein may be combined with every other element, feature, combination and sub-combination disclosed herein.

It will be appreciated by those skilled in the art that changes could be made to the embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A drift elimination system configured for the removal of liquid entrained in an air flow, comprising,
At least one first electrode located in a liquid droplet-containing air flow downstream of liquid dispersion media in an air-flow direction and configured to impart an electrical charge to liquid droplets passing by or through said first set of electrodes,
At least one second electrode located downstream of said first set of electrodes in said air-flow direction, configured to be energized with an opposite electrical charge from said first set of electrodes.

2. The drift elimination system according to claim 1, wherein said at least one first electrode comprises an array of metal needles.

3. The drift elimination system according to claim 1, wherein said at least one first electrode comprises a plurality of metal plates.

4. The drift elimination system according to claim 1, wherein said at least one second electrode comprises a set of wavy metal plates.

5. The drift elimination system according to claim 1, wherein said at least one second electrode comprise a wire mesh.

6. The drift elimination system according to claim 1 installed below a fan and above a water distribution system in a counterflow evaporative cooling tower.

7. The drift elimination system according to claim 1, installed laterally adjacent to a heat exchange area containing water dispersion media in a crossflow evaporative cooling tower.

8. The drift elimination system according to claim 1, installed vertically higher than a water distribution system in a crossflow evaporative cooling tower.

9. The drift elimination system according to claim 1, installed in a throat of a natural draft cooling tower.

10. The drift elimination system according to claim 1, installed downstream from a reaction unit in said air flow direction in an air contacting system for the removal of carbon dioxide or other pollutants from air and where the liquid droplets comprise a reaction fluid.

11. The drift elimination system according to claim 1, further comprising one or more packs of polymer sheets located upstream in said air-flow direction of said first set of electrodes.

12. A method for removing liquid droplets from an air flow comprising:
using at least one first electrostatically charged electrode to induce an electric charge on a surface of said liquid droplets to produce electrostatically charged liquid droplets;
using a sat least one second electrostatically charged electrode to capture said electrostatically charged liquid droplets.

13. The method of claim 12, wherein said at least one first electrostatically charged electrode has a positive electrostatic charge and said at least one second electrostatically charged electrode has a negative electrostatic charge.

14. The method of claim 12, wherein said at least one first electrostatically charged electrode has a negative electrostatic charge and said at least one second electrostatically charged electrode has a positive electrostatic charge.
